(19) United States
(12) Patent Application Publication
(10) Pub. No.: US 2025/0149022 A1
(43) Pub. Date: May 8, 2025

(54) Text-Conditioned Speech Inpainting

(71) Applicant: Google LLC, Mountain View, CA (US)

(72) Inventors: Zalán Borsos, Zurich (CH); Marco Tagliasacchi, Kilchberg (CH); Matthew Sharifi, Kilchberg (CH)

(21) Appl. No.: 18/837,723

(22) PCT Filed: Feb. 13, 2023
(86) PCT No.: PCT/US2023/012947

§ 371 Date: Aug. 12, 2024

Related U.S. Application Data
(60) Provisional application No. 63/309,075, filed on Feb. 11, 2022.

(51) Int. Cl. G10L 13/08; G10L 25/30

(52) U.S. Cl. CPC G10L 13/08; G10L 25/30

(57) ABSTRACT

Provided are systems, methods, and machine learning models for filling in gaps (e.g., of up to one second) in speech samples by leveraging an auxiliary textual input. Example machine learning models described herein can perform speech inpainting with the appropriate content, while maintaining speaker identity, prosody and recording environment conditions, and generalizing to unseen speakers. This approach significantly outperforms baselines constructed using adaptive TTS, as judged by human raters in side-by-side preference and MOS tests.

### RELATED APPLICATIONS

This application claims priority to and the benefit of U.S. Provisional Patent Application No. 63/309,075, filed Feb. 11, 2022. U.S. Provisional Patent Application No. 63/309,075 is hereby incorporated by reference in its entirety.

### FIELD

The present disclosure relates generally to speech inpainting for audio data. More particularly, the present disclosure relates to using audio spectrograms and associated textual transcripts to inpaint missing audio data into the audio spectrograms.

### BACKGROUND

Applications involving recognition, enhancement, and recovery of signals in one modality can often benefit from input from other modalities. In the context of speech processing, there have been several efforts to separate, enhance, or recover target speech sources based on visual and other sensory modalities. On the other hand, recovering speech based on text has received little attention, despite its wide range of use-cases.

### SUMMARY

Aspects and advantages of embodiments of the present disclosure will be set forth in part in the following description, or can be learned from the description, or can be learned through practice of the embodiments.

One example aspect of the present disclosure is directed to a method for performing audio inpainting. The method includes receiving, by a computing system comprising one or more computing devices, an audio spectrogram, the audio spectrogram including at least one portion lacking audio content. The method includes receiving, by the computing system, a textual transcript associated with the audio spectrogram and including text corresponding to the at least one portion lacking audio content. The method includes processing, by the computing system, the audio spectrogram and the textual transcript with a machine-learned audio inpainting model to generate replacement audio content for the at least one portion of the audio spectrogram lacking audio content. The method includes outputting, by the computing system, a completed audio spectrogram, the completed audio spectrogram having the replacement audio content in place of the at least one portion of the audio spectrogram lacking audio content.

Another example aspect of the present disclosure is directed to a system for performing audio inpainting. The system includes one or more processors and a non- transitory, computer-readable medium storing instructions that, when executed by the one or more processors, cause the one or more processors to perform operations. The operations include receiving an audio spectrogram, the audio spectrogram including at least one portion lacking audio content. The operations include receiving a textual transcript associated with the audio spectrogram. The operations include processing the audio spectrogram and the textual transcript with a machine-learned audio inpainting model to generate replacement audio content for the at least one portion of the audio spectrogram lacking audio content. The operations include outputting a completed audio spectrogram, the completed audio spectrogram having the replacement audio content in place of the at least one portion of the audio spectrogram lacking audio content.

Another example aspect of the present disclosure is directed to a non-transitory, computer-readable medium storing instructions that, when executed by one or more processors, cause the one or more processors to perform operations. The operations include receiving a set of training data, the set of training data including a plurality of training audio spectrograms, each of the training audio spectrograms of the plurality of training audio spectrograms having an associated training textual transcript. The operations include generating a plurality of masked audio spectrograms by masking random consecutive frames of each training audio spectrogram of the plurality of training audio spectrograms, wherein each masked audio spectrogram of the plurality of masked audio spectrograms is associated with the training audio spectrogram used to generate the masked audio spectrogram and the training textual transcript associated with the training audio spectrogram. The operations include processing a masked audio spectrogram of the plurality of masked audio spectrograms and the training textual transcript associated with the masked audio spectrogram with a machine-learned audio inpainting model to generate an output spectrogram having replacement audio content in place of the masked frames of the masked audio spectrogram. The operations include evaluating a loss function that compares the output spectrogram with the training audio spectrogram associated with the masked audio spectrogram. The operations include modifying one or more parameters of the machine-learned audio inpainting model based on the loss function.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts an example model for performing speech inpainting using textual transcripts and audio spectrograms according to example embodiments of the present disclosure.

FIG. 1B provides a graphical diagram of one example architecture of a discriminator model according to example embodiments of the present disclosure.

FIG. 2A depicts a block diagram of an example computing system that performs speech inpainting according to example embodiments of the present disclosure.

FIG. 2B depicts a block diagram of an example computing device that performs speech inpainting according to example embodiments of the present disclosure.

FIG. 2C depicts a block diagram of an example computing device that performs speech inpainting according to example embodiments of the present disclosure.

Reference numerals that are repeated across plural figures are intended to identify the same features in various implementations.

### DETAILED DESCRIPTION

### Overview

Generally, the present disclosure is directed to systems, methods, and machine learning models for filling in gaps (e.g., of up to one second) in speech samples by leveraging an auxiliary textual input. Example machine learning models described herein can perform speech inpainting with the appropriate content, while maintaining speaker identity, prosody and recording environment conditions, and generalizing to unseen speakers. This approach significantly outperforms baselines constructed using adaptive text-to-speech (TTS), as judged by human raters in side-by-side preference and Mean Opinion Score (MOS) tests.

More particularly, text-conditioned speech inpainting can be useful in several use-cases. For example, it could serve as a tool for users with speech impairments or language learners for fixing mispronounced words in recorded audio. In a similar manner, the model could be used for correcting grammar and word choice mistakes, as well as for restoring parts of speech affected by packet losses or excessive background noise.

The problem of unconditional speech inpainting has attempted to be addressed in other technologies, with the main focus on packet loss concealment. These methods are only practical for short gap sizes (e.g., less than 250 ms). Relying on another modality for conditioning can enable the inpainting of longer gaps. When conditioning on text, certain speech inpainting approaches of other technologies can operate with gaps up to 750 ms. However, these methods require a significant amount of parallel training data for each target speaker, which is impractical to collect in many settings.

Recent advances in text-to-speech (TTS) systems demonstrate the capability of TTS to synthesize speech while transferring speaker identity, prosody and some recording environment conditions from a short target speech sample. In fact, such approaches may provide some baseline performance for different use cases, provided that an additional module is designed for detecting the part of the synthesized speech corresponding to the gap, and “stitching” it back into the gap's place.

In view of the above, example implementations of the present disclosure can perform text-conditioned speech inpainting, (named by analogy with image inpainting, where a region of unknown pixels is inferred from the surrounding observed pixels), where the task is to infer a segment of missing speech (e.g., up to one second, or longer), given two inputs: i) the surrounding observed speech in an utterance, and ii) a transcript of the entire utterance, including both the missing and observed speech. In order to sound natural, the infilled audio preserves speaker identity, prosody, recording environment conditions (e.g., reverb, background noise, bandpass filtering and other artifacts due to the recording microphone) and its speech content corresponds to the missing part according to the transcript. The approach generalizes to unseen speakers and content without any additional context provided besides the original short speech sample with the gap and the transcript.

Thus, the present disclosure proposes machine-learned audio inpainting models (example implementations of which can be referred to as SpeechPainter) that are capable of handling, for example, the challenging setup of text-conditioned speech inpainting described in the preceding paragraph. It is demonstrated that the model can synthesize the missing speech content based on an unaligned transcript, while maintaining speaker identity, prosody and recording environment conditions. In some example implementations, the model architecture can be based on previously-articulated machine learning model architectures, such as Perceiver IO, that include scalable architectures for multi-modal data that have demonstrated excellent performance and versatility over a range of tasks and input/output modalities. The Perceiver IO architecture is described at Jaegle et al., Perceiver IO: A General Architecture for Structured Inputs & Outputs, arXiv:2107.14795 and 2107.14795v2.

Another valuable component for generating artifact-free speech is adversarial training with feature matching losses, commonly used in high-fidelity speech synthesis. The proposed approach significantly outperforms baselines constructed using adaptive TTS, as measured by MOS of human raters.

The proposed systems and methods allow improved pronunciation, correction of corrupted, inaudible, and/or otherwise vague and uncertain audio data, accessibility for impaired speakers, and/or the like. The proposed systems and methods can inpaint speech into areas of recorded audio in which audio data is lacking while maintaining idiosyncrasies of the audio data, such as speaker identity, prosody, recording environment conditions (e.g., reverb, background noise, bandpass filtering and/or other artifacts due to the recording microphone). The generated audio data can include speech content corresponding to the missing part according to the transcript while mainlining those idiosyncrasies. In this way, the model can be used in a variety of applications, such as assisting those with speech impairments, aiding in populating corrupted audio files with accurate audio data reconstruction, assisting in improving pronunciation, correction of corrupted, inaudible, and/or otherwise vague and uncertain audio data, accessibility for impaired speakers, and/or the like. Thus, the proposed techniques represent an improvement in the functioning of a speech generation system.

Additionally, the proposed systems and methods provides benefits in increased computing efficiency, especially for speech inpainting models. In particular, the learning setup of the proposed systems and methods does not require aligned transcripts or parallel speech data from the target speakers, and thus reduces the amount of training cycles required to train the model, which saves processing power and time, memory, network bandwidth, and the like required to train a machine learning model. Furthermore, less processing bandwidth, less memory, and less network bandwidth is needed to handle the transfer of, creation of, storage of, and analysis of training data.

Additionally, the proposed system and methods is user agnostic, which means that one model can be used for all speaker identities without the need for training data from a specific user. Thus, in some implementations, a single model can be trained and used, rather than generating a different model for each different user, as is required in some existing systems. By generating a single model rather than a large number of models, the proposed techniques can reduce the amount of training cycles performed overall, which saves processing power and time, memory, network bandwidth, and the like.

With reference now to the Figures, example embodiments of the present disclosure will be discussed in further detail.

### EXAMPLE SPEECH INPAINTING TECHNIQUES

This section first describes example objectives of example implementations. First, the model can fill in a gap (e.g., of up to one second) in a speech segment given the corresponding transcript. Second, in favor of simplicity and minimal effort for training data preparation, it can be assumed that the transcript is not aligned with the corresponding speech sample. This allows for longer transcripts that have a subsequence covering the content of the speech sample with the gap. In this setup, the model should learn to discover the part of the transcript corresponding to the gap and synthesize its content accordingly. Training data preparation for this setup can be performed as follows: take any speech dataset containing speech samples and transcripts (e.g., LibriTTS, VCTK), randomly crop the speech samples to a few seconds, randomly create the gap and retain the whole original transcript. Third, for the sake of generality, it can be required that the runtime and memory complexity of the model should scale well in terms of the length of the speech sample and transcripts, thus allowing the model to operate on longer sequences.

### Example Models

Some implementations of the audio inpainting models described herein can be based on existing architectures, such as the architecture of Perceiver IO, which can be capable of fulfilling the aforementioned requirements. In particular, architectures such as Perceiver IO scale linearly in runtime and memory complexity with respect to the input and output sizes. This can be achieved by processing the input using a cross-attention module with a learned latent query L to a fixed-size latent space, which can be then processed by a Transformer. Analogously, the output can be constructed by cross-attending to the latent space using a learned output query Q. The choice of architectures such as Perceiver IO as a base model, in contrast to autoregressive approaches, also allows for the use of adversarial training, which is crucial for removing robotic artifacts from the inpainted sequence.

Instead of working with audio in the time domain, example implementations of the technology can work with the more compact log-scale mel spectrogram representation. This representation disregards phase information and emphasizes lower frequency details important for understanding speech, but also admits inversion algorithms capable of reproducing the audio in time domain with high fidelity. In experiments, a neural vocoder can be used to perform the audio synthesis from log-mel spectrograms. The architecture of the vocoder can be identical to MelGAN (Kumar et al., MelGAN: Generative Adversarial Networks for Conditional Waveform Synthesis. In Advances in Neural Information Processing Systems (NeurIPS), volume 32, 2019), but it can be trained with a multi-scale reconstruction loss as well as adversarial losses from both wave- and STFT-based discriminators.

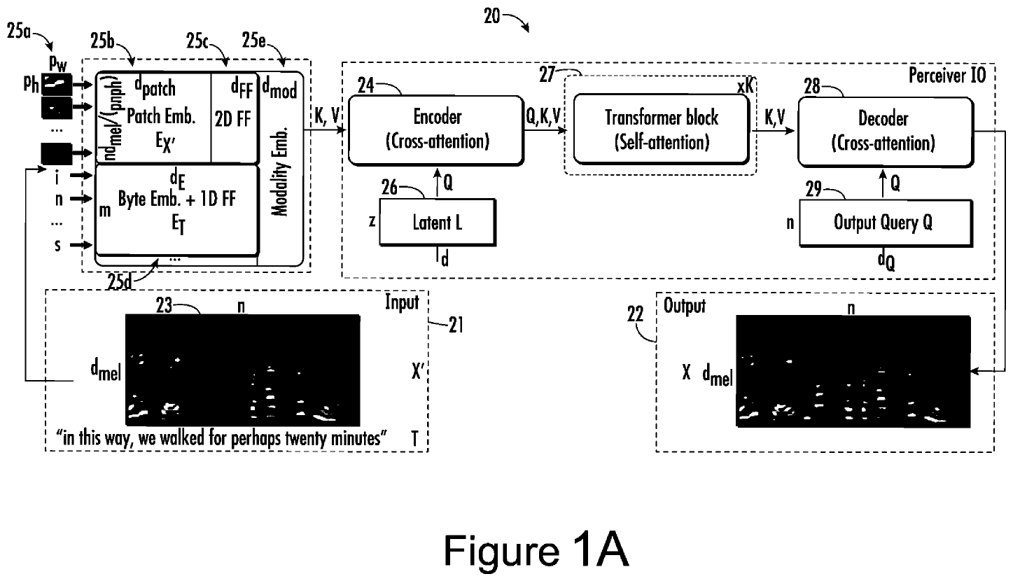

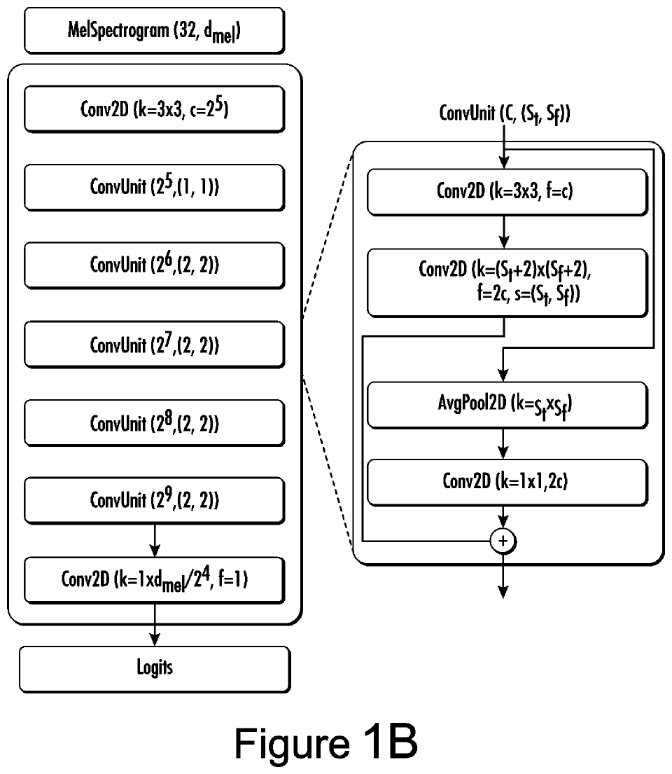

An example architecture of a model 20 for performing audio inpainting, such as the SpeechPainter model, is shown in FIG. 1A. The input 21 and output 22 of the model 20 are (X′, T) and X, respectively, where X ∈ [symbol] ^{n×d}^{ₘₑₗ} is the log-mel spectrogram of the target sample (without gap), T is the transcript, X′:=mask(X) and mask(·) is an augmentation that masks consecutive frames of the spectrogram, creating a gap 23 of pre-defined or random length covering, as an example, at most one second, starting at a random timestamp. The maximum length of one second is provided as an example only. Longer gaps can be used, but may result in reduced performance. The desired performance level may be implementation specific.

The input keys/values to the model's encoder 24 (e.g., the first cross-attention) can be constructed as follows. The log-mel spectrogram X′ can be split into non-overlapping patches 25a of size p_{w}×pₕ, and the resulting patches 25a can be embedded to d_{patch}-dimensional representations 25b through a learned linear layer after flattening. Then, the sequence of patches 25a can be concatenated with 2D Fourier positional encodings 25c (FF, Fourier features) of dimensions d_{FF}, resulting in the spectrogram embedding E_{X}, ∈ [symbol] ^{(n·d}^{ₘₑₗ}^{/(P}^{_{w}}^{·P}^{ₕ}^{))×d}^{_{E}}, where d_{E}=d_{patch}+d_{FF}. For embedding the transcript, T can be first padded using whitespaces to length m (the maximum number of characters accepted by the model) and can then be UTF-8 byte-embedded with embedding dimension of d_{E}. T can then be summed with Fourier positional encodings 25_{d} to obtain the text embedding E_{T} ∈ [symbol] ^{m×d}^{_{E}} (Text embedding shown at 25d). Finally, learnable modality embeddings e_{X}, e_{T} ∈ [symbol] ^{d}^{_{mod}} 25ecan be appended to E_{X}, and E_{T}, respectively, the concatenation of which is the key/value to the encoder's 24 cross-attention.

A learned latent L ∈ [symbol] ^{z×d} 26 can serve as the query to the encoder 24, the output of which can be attended to by k Transformer-style self-attention blocks 27. The task of the decoder 28 is to produce the target log-mel spectrograms. To achieve this, the decoder's 28 cross-attention receives as a query a learned output query Q ∈ [symbol] ^{n×d}^{_{Q}} 29 and as a key/value the output of the final self-attention layer of the Transformer blocks 27. Finally, the output 22 of the decoder 28 can be projected along the last dimension to match the dimension of the target spectrogram.

### Example Two-phase Training

In some implementations, the audio inpainting model (e.g., model 20) can be trained in two consecutive phases in order to achieve both signal reconstruction fidelity and perceptual quality. In the first phase the model 20 can be trained with the L₁ reconstruction loss on log-mel spectrograms,

$${ℒ}_{𝒢}^{r e c} = \frac{1}{n {d}_{mel}} {𝔼}_{( X , T )} [ {‖ X - 𝒢 ( {X}^{′} , T ) ‖}_{1} ] ,$$

where [symbol] denotes the model (e.g., model 20). With this choice of loss function, the model can learn to correctly identify and inpaint the content of the gap 23 based on the transcript, maintaining speaker identity, prosody and recording environment conditions. However, the results can in some cases contain robotic artifacts.

Therefore, in some implementations, a second training phase can optionally be used, where adversarial training can be performed in order to achieve higher perceptual quality. A discriminator model [symbol] can be instantiated with the objective to differentiate between synthesized and real mel spectrogram chunks corresponding to 400 ms (e.g., 32 mel frames) of audio. At the same time, [symbol] can be optimized to produce outputs that are indistinguishable from the ground truth by matching the feature representations in all layers of [symbol] . As one example, [symbol] can be a convolutional network closely resembling a single scale STFT discriminator, such as a single scale STFT discriminator as described in Zeghidour et al., “Soundstream: An end-to-end neural audio codec,” 2021. The discriminator can be trained with the hinge loss,

$${ℒ}_{𝒟} = {𝔼}_{( X , T )} [ {\sum }_{t} max ( 0 , 1 - {𝒟}_{t} ( X ) ) ] + {𝔼}_{( X , T )} [ {\sum }_{t} max ( 0 , 1 + {𝒟}_{t} ( 𝒢 ( {X}^{′} , T ) ) ) ] ,$$

where [symbol] ₜ is the t-th logit of the discriminator along the time axis. The feature matching loss for [symbol] can be defined as

$${ℒ}_{𝒢}^{f e a t} = {𝔼}_{( X , T )} [ \frac{1}{ℓ} {\sum }_{i = 1}^{ℓ} \frac{1}{{d}_{i}} {‖ {𝒟}^{i} ( X ) - {𝒟}^{i} ( 𝒢 ( {X}^{′} , T ) ) ‖}_{1} ]$$

where [symbol] is the number of layers of [symbol] , [symbol] ⁱ denotes the discriminator features at layer i and dᵢ is the dimension of [symbol] ⁱ. In the second phase of the training, [symbol] can be optimized using the loss [symbol] +λ_{feat} [symbol] with, as one example, λ_{feat}=10.

More generally, training can occur in one or multiple phases using any combination or sequence of one or more of the training losses described above.

FIG. 1B provides a graphical diagram of one example architecture of the discriminator operating on logmel spectogram chunks. The convolution parameters k, f, s denote the kernel size, number of filters and strides, respectively. The first two convolutions in each block can be preceded by ELU activation, and all convolution layers except the last can use layer normalization.

### EXAMPLE DEVICES AND SYSTEMS

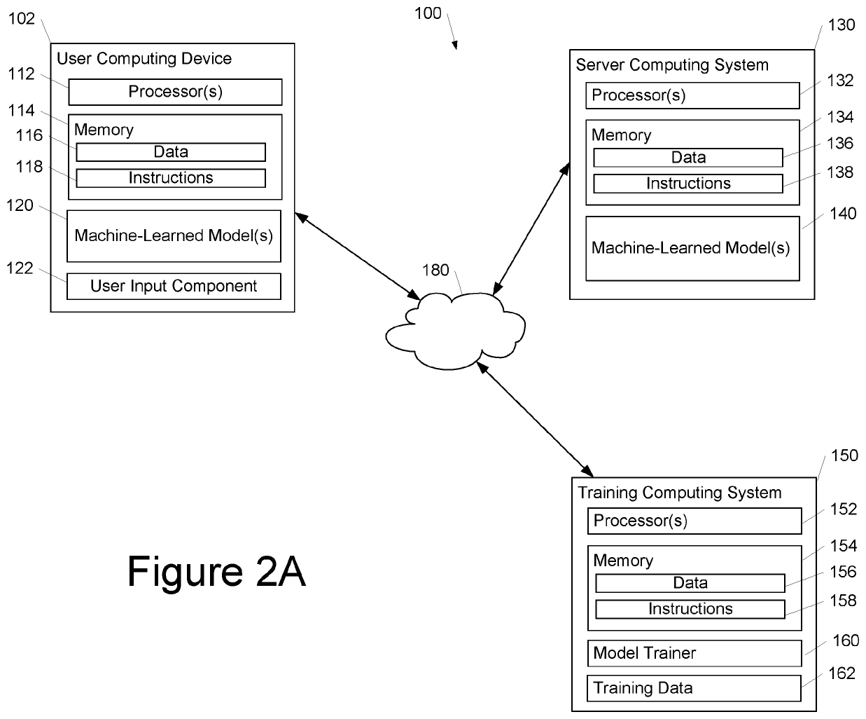

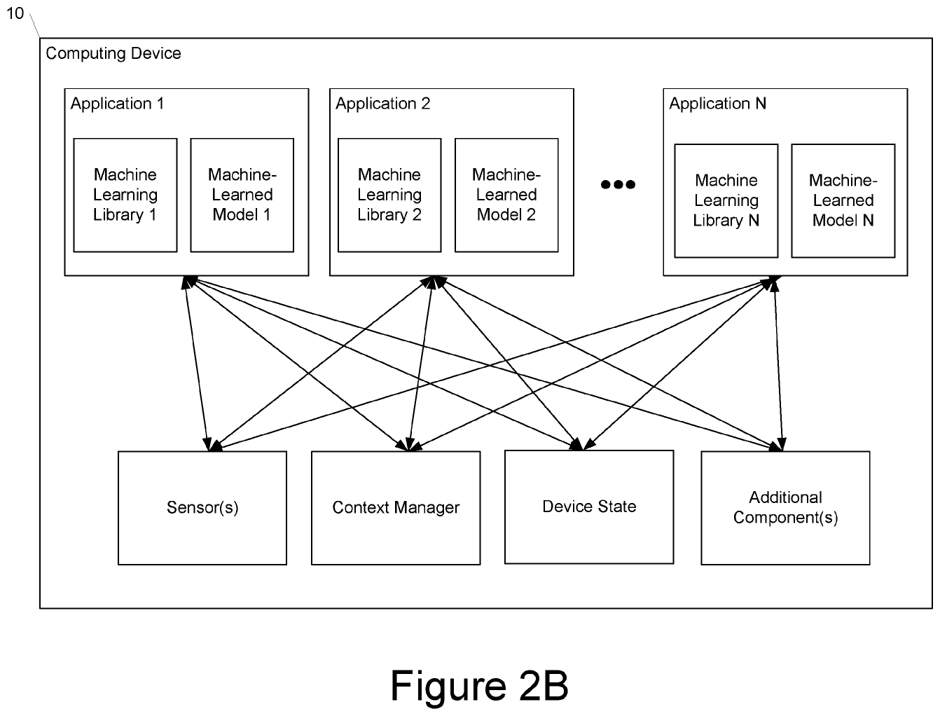

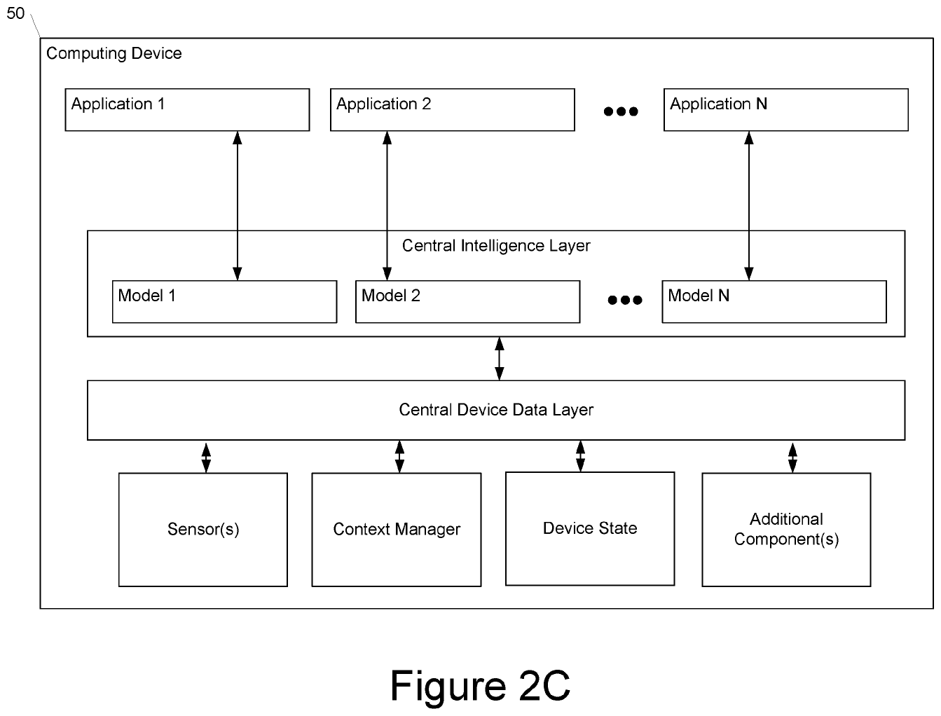

FIG. 2A depicts a block diagram of an example computing system 100 that performs speech inpainting using audio spectrograms and associated textual transcripts according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned audio inpainter models 120. For example, the machine-learned audio inpainter models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned audio inpainter models 120 are discussed with reference to FIG. 1A.

In some implementations, the one or more machine-learned audio inpainter models 120 can be received from the server computing system 130 over network 180, stored in the user computing device memory 114, and then used or otherwise implemented by the one or more processors 112. In some implementations, the user computing device 102 can implement multiple parallel instances of a single machine-learned audio inpainter model 120 (e.g., to perform parallel speech inpainting across multiple instances of speech inpainting).

More particularly, the machine-learned audio inpainter model 120 is used to perform speech inpainting using audio spectrograms and associated textual transcripts. The machine-learned audio inpainter model 120 receives an audio spectrogram that includes missing and/or corrupted audio data. Machine-learned audio inpainter model 120 processes the audio spectrogram to fill in, or inpaint, the missing and/or corrupted audio data with the appropriate content, while maintaining speaker identity, prosody and recording environment conditions, and generalizing to unseen speakers. This is accomplished using the textual transcript. The machine-learned audio inpainter model 120 analyzes the audio spectrogram and the textual transcript to generate values audio data values for the missing and/or corrupted audio data portion of the audio spectrogram. The textual transcript is to generate the spoken word content missing from the audio spectrogram and provide additional assistance in generating the audio data values that will be inpainted into the audio spectrogram.

The generated audio data values replace the missing and/or corrupted audio data and the resulting, newly inpainted audio spectrogram is output from the model.

Additionally or alternatively, one or more machine-learned audio inpainter models 140 can be included in or otherwise stored and implemented by the server computing system 130 that communicates with the user computing device 102 according to a client-server relationship. For example, the machine-learned audio inpainter models 140 can be implemented by the server computing system 140 as a portion of a web service (e.g., a speech inpainting service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned audio inpainter models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIG. 1A.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned audio inpainter models 120 and/or 140 based on a set of training data 162. The training data 162 can include, for example, audio spectrograms and textual transcripts associated with each audio spectrogram. The textual transcript associated with each audio spectrogram can be an unaligned textual transcript. Training data preparation for this setup can include taking any speech dataset containing speech samples and transcripts (e.g., LibriTTS, VCTK), randomly cropping the speech samples to a few seconds, randomly creating a gap in the cropped samples, and retaining the whole original transcript. The cropped samples and the transcripts are provided as input, with the original audio spectrogram provided as ground truth output.

In some implementations, if the user has provided consent, training examples associated with the user can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 2A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 2B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 2B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 2C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 2C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 2C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A method for performing audio inpainting, the method comprising:
receiving, by a computing system comprising one or more computing devices, an audio spectrogram, the audio spectrogram including at least one portion lacking audio content;
receiving, by the computing system, a textual transcript associated with the audio spectrogram and including text corresponding to the at least one portion lacking audio content;
processing, by the computing system, the audio spectrogram and the textual transcript with a machine-learned audio inpainting model to generate replacement audio content for the at least one portion of the audio spectrogram lacking audio content; and
outputting, by the computing system, a completed audio spectrogram, the completed audio spectrogram having the replacement audio content in place of the at least one portion of the audio spectrogram lacking audio content.

2. The method of claim 1, wherein processing, by the computing system, the audio spectrogram with the machine-learned audio inpainting model comprises:
splitting, by the computing system, the audio spectrogram into non-overlapping patches;
embedding, by the computing system, each patch of the non-overlapping patches into a one-dimensional representation of the patch;
concatenating, by the computing system, the one-dimensional representations into a spectrogram embedding; and
concatenating the spectrogram embedding with two-dimensional Fourier positional encodings.

3. The method of claim 2, the method further comprising:
padding, by the computing system, the textual transcript with whitespaces to a desired length;
embedding, by the computing system, the padded textual transcript using byte-embedding;
summing, by the computing system, the embedded textual transcript using Fourier positional encodings; and
generating, by the computing system, a text embedding based on the summed textual transcript.

4. The method of claim 1, the method further comprising training, by the computing system, the machine-learned audio inpainting model, wherein training the machine-learned audio inpainting model comprises:
receiving, by the computing system, a set of training data, the set of training data including a plurality of training audio spectrograms, each of the training audio spectrograms of the plurality of training audio spectrograms having an associated training textual transcript;
generating, by the computing system, a plurality of masked audio spectrograms by masking random consecutive frames of each training audio spectrogram of the plurality of training audio spectrograms, wherein each masked audio spectrogram of the plurality of masked audio spectrograms is associated with the training audio spectrogram used to generate the masked audio spectrogram and the training textual transcript associated with the training audio spectrogram;
processing, by the computing system, a masked audio spectrogram of the plurality of masked audio spectrograms and the training textual transcript associated with the masked audio spectrogram with the machine-learned audio inpainting model to generate an output spectrogram having replacement audio content in place of the masked frames of the masked audio spectrogram;
evaluating, by the computing system, a loss function that compares the output spectrogram with the training audio spectrogram associated with the masked audio spectrogram; and
modifying one or more parameters of the machine-learned audio inpainting model based on the loss function.

5. The method of claim 4, wherein training the machine-learned audio inpainting model comprises:
performing, by the computing system, a first training phase, the first training phase comprising using a reconstruction loss function to train the machine-learned audio inpainting model to identify and inpaint content of the portion of the audio spectrogram with the generated output to generate the completed audio spectrogram; and
performing, by the computing system, a second training phase, the second training phase comprising using adversarial training to achieve higher perceptual quality and remove artifacts from the completed audio spectrogram.

6. The method of claim 5, where the reconstruction loss function determines a difference between the audio spectrogram used to generate the masked audio spectrogram and the completed audio spectrogram.

7. The method of claim 5, wherein the adversarial training comprises using a discriminator model to differentiate between synthesized audio spectrograms and real audio spectrograms.

8. The method of claim 1, wherein the received textual transcript is an unaligned textual transcript.

9. The method of claim 1, wherein the textual transcript comprises a sequence of natural language characters.

10. The method of claim 1, wherein the textual transcript includes textual content for the at least one portion of the audio spectrogram lacking audio content.

11. The method of claim 1, wherein the machine-learned audio inpainting model comprises a learned latent query and a learned output query.

12. A system for performing audio inpainting, the system comprising:
one or more processors; and
a non-transitory, computer-readable medium storing instructions that, when executed by the one or more processors, cause the one or more processors to perform operations, the operations comprising:
receiving an audio spectrogram, the audio spectrogram including at least one portion lacking audio content;
receiving a textual transcript associated with the audio spectrogram;
processing the audio spectrogram and the textual transcript with a machine-learned audio inpainting model to generate replacement audio content for the at least one portion of the audio spectrogram lacking audio content; and
outputting a completed audio spectrogram, the completed audio spectrogram having the replacement audio content in place of the at least one portion of the audio spectrogram lacking audio content.

13. The system of claim 12, wherein processing the audio spectrogram with the machine-learned audio inpainting model comprises:
splitting the audio spectrogram into non-overlapping patches;
embedding each patch of the non-overlapping patches into a one-dimensional representation of the patch;
concatenating the one-dimensional representations into a spectrogram embedding; and
concatenating the spectrogram embedding with two-dimensional Fourier positional encodings.

14. The system of claim 12, the operations further comprising:
padding the textual transcript with whitespaces to a desired length;
embedding the padded textual transcript using byte-embedding;
summing the embedded textual transcript using Fourier positional encodings; and
generating a text embedding based on the summed textual transcript.

15. The system of claim 12, the operations further comprising training the machine-learned audio inpainting model, wherein training the machine-learned audio inpainting model comprises:
receiving a set of training data, the set of training data including a plurality of training audio spectrograms, each of the training audio spectrograms of the plurality of training audio spectrograms having an associated training textual transcript;
generating a plurality of masked audio spectrograms by masking random consecutive frames of each training audio spectrogram of the plurality of training audio spectrograms, wherein each masked audio spectrogram of the plurality of masked audio spectrograms is associated with the training audio spectrogram used to generate the masked audio spectrogram and the training textual transcript associated with the training audio spectrogram;
processing a masked audio spectrogram of the plurality of masked audio spectrograms and the training textual transcript associated with the masked audio spectrogram with the machine-learned audio inpainting model to generate an output spectrogram having replacement audio content in place of the masked frames of the masked audio spectrogram;
evaluating a loss function that compares the output spectrogram with the training audio spectrogram associated with the masked audio spectrogram; and
modifying one or more parameters of the machine-learned audio inpainting model based on the loss function

16. The system of claim 15, where the loss function comprises a reconstruction loss function that determines a difference between the audio spectrogram used to generate the masked audio spectrogram and the completed audio spectrogram.

17. The system of claim 15, wherein the loss function comprises an adversarial training loss function that uses a discriminator model to differentiate between synthesized audio spectrograms and real audio spectrograms

18. The system of claim 12, wherein the received textual transcript is an unaligned textual transcript.

19. The system of claim 12, wherein the machine-learned audio inpainting model comprises a learned latent query and a learned output query.

20. A non-transitory, computer-readable medium storing instructions that, when executed by one or more processors, cause the one or more processors to perform operations, the operations comprising:
receiving a set of training data, the set of training data including a plurality of training audio spectrograms, each of the training audio spectrograms of the plurality of training audio spectrograms having an associated training textual transcript;
generating a plurality of masked audio spectrograms by masking random consecutive frames of each training audio spectrogram of the plurality of training audio spectrograms, wherein each masked audio spectrogram of the plurality of masked audio spectrograms is associated with the training audio spectrogram used to generate the masked audio spectrogram and the training textual transcript associated with the training audio spectrogram;
processing a masked audio spectrogram of the plurality of masked audio spectrograms and the training textual transcript associated with the masked audio spectrogram with a machine-learned audio inpainting model to generate an output spectrogram having replacement audio content in place of the masked frames of the masked audio spectrogram;
evaluating a loss function that compares the output spectrogram with the training audio spectrogram associated with the masked audio spectrogram; and
modifying one or more parameters of the machine-learned audio inpainting model based on the loss function.
